(19) United States
(12) Patent Application Publication
(10) Pub. No.: US 2012/0003475 A1
(43) Pub. Date: Jan. 5, 2012

(54) Synthesis Methodology to Produce Nano Metal Organic Framework Crystals

(75) Inventors: Annabelle BENIN, Oak Forest, IL (US); Richard R. Willis, Cary, IL (US)

(73) Assignee: UOP LLC, Des Plaines, IL (US)

(21) Appl. No.: 12/827,643

(22) Filed: Jun. 30, 2010

(51) Int. Cl. C07F 1/08; C07F 5/06; C07F 15/04; C07F 15/06; C07F 3/02; B32B 5/16; C07F 3/06

(52) U.S. Cl. 428/402; 556/115; 556/184; 556/132; 556/147; 562/480

(57) ABSTRACT

A method for synthesizing particulate or loosely agglomerated nano-metal organic framework crystals having an average particle size less than 100 nm. A base compound is added to a solution of a metal salt and an organic polydentate ligand with thorough stirring at a temperature between about 15° C. and about 30° C. for a time less than about 4 hours.

### FIELD

The invention relates generally to a method for synthesizing metal organic framework crystals. More particularly, the invention relates to a method for synthesizing nano-scale metal organic framework crystals. The invention also relates to metal organic framework crystals produced by the method.

### DESCRIPTION OF RELATED ART

Known substance classes of porous solids are called metal organic frameworks (MOF) or metal organic coordination polymers (MOCP). The theory of coordination bonds developed by Alfred Werner [A. Werner, Z. Anorg. Allg. Chem. 3 (1893) 267] made it possible for the first time to understand the experimental results of complex inorganic chemistry. Stable coordination polymers are obtained by adding organic molecules capable of complex formation, like diamines or diacids, to dissolved inorganic salts. The distances between the metal-containing structural building units (SBUs) as coordination centers can be set in a wide range through the structure, in particular of the organic components, and result in micro- to meso-porous substances. Coordination polymers can thus be varied and are substantially documented [S. Kitagawa, et al. Angew. Chem. Int. Ed. 43 (2004) 2334].

Metal organic framework crystals are a relatively new class of porous materials constructed from transition metal-containing SBUs and linkers, or bridging organic ligands. Metal organic framework crystals are useful as molecular sieves and in separation processes, catalysis, non-linear optics, and storage of gases. The atomic structure of any coordination polymers can be determined by x-ray crystallography, and the dimensions of the pores or channels can be determined with excellent certainty. The internal surface areas of some porous coordination polymers are significantly greater than the internal surface areas of other porous materials. The pore sizes and shapes theoretically are highly tunable and large pore sizes can be synthesized when compared to the pore sizes of known zeolites. Functionalization of the backbones or frameworks in these materials can be achieved by starting the synthesis with organic linkers with functional groups already in place or by post-synthesis modification.

Because metal organic framework crystals are constructed from discrete components, it is possible in theory to design a crystal to achieve selected properties and characteristics, such as crystal porosity and pore size, topology, and functionality at the surface of the particle. However, execution of such designs in a commercially practical way often is illusive. Often, reaction paths take multiple days, which can be commercially uneconomic.

Therefore, there exists a need for a method for synthesizing metal organic framework crystals having desired properties and characteristics in a commercially practical way.

### SUMMARY OF THE INVENTION

Aspects of this invention relate to a method for synthesizing metal organic framework crystals. More particularly, the invention relates to a method for synthesizing nano-scale metal organic framework crystals. The invention also relates to metal organic framework crystals produced by the method.

### BRIEF DESCRIPTION OF THE DRAWINGS

FIGS. 1A-1C are XRD patterns of nano-metal organic framework crystals of different MOF embodiments of the invention.

FIGS. 2A-2D are XRD patterns of nano-metal organic framework crystal embodiments of the invention comprising different metals. FIG. 2E is a simulated XRD pattern for this MOF.

FIGS. 3A-3D are SEM depictions of the same nano-metal organic framework crystal embodiments of the invention as in FIGS. 2A-2D.

FIGS. 4A-4E are XRD patterns for composition embodiments of the invention synthesized at different base/acid ratios. FIG. 4F is a calculated XRD pattern for this MOF.

FIGS. 5A-5C are sorption/desorption curves for nano-metal organic framework crystal embodiments of the invention having different metals.

FIG. 6A is an SEM depiction of a known MOF, and FIGS. 6B and 6C are SEM depictions of nano-metal organic framework crystal embodiments of the invention.

FIGS. 7A-7D are SEM depictions of embodiments of the invention made with and without additives.

FIGS. 8A and 8B are XRD patterns for the products of FIGS. 7A-7D. FIG. 8C is a calculated XRD pattern for this product.

FIGS. 9A-9D are SEM depictions illustrating uniformity achieved for MOF embodiments of the invention made in a mixed solution as compared with embodiments of the invention made in a single solvent.

FIGS. 10A and 10B are XRD patterns for the products of FIGS. 9A-9D. FIG. 10C is a calculated XRD pattern.

FIGS. 11A-11D are XRD patterns for embodiments of the invention made in the presence of different additives.

FIGS. 12A-12H are SEM depictions of the products of FIGS. 11A-11D.

### DETAILED DESCRIPTION

The invention relates to a method for synthesizing nano-scale metal organic framework crystals. In particular, the invention relates to a method for synthesizing nano-scale metal organic framework crystals. The invention also relates to metal organic framework crystals produced by the method.

Embodiments of the invention are directed to a method for synthesizing nano-scale metal organic framework crystals. In particular, embodiments of the invention are directed to nano-scale metal organic framework crystals that are coordination polymers comprising metal-containing building units connected with linkers. The structural building units comprise metal and may have other elements present, and the linkers are organic compounds that react with the transition metal-containing species to form a metal organic framework.

Nano-scale metal organic framework crystal embodiments of the invention have properties and characteristics that make the crystals suitable for many uses, including in separation processes, catalysis, non-linear optics, and storage of gases. Nano-scale metal organic framework crystals embodiments of the invention act as molecular sieves and provide excellent selectivity for separation processes. Also, nano-scale metal organic framework crystals can be used to store or immobilize gases to provide safer gas storage and improve processes in which an immobilized gas can serve as a reactant or a catalyst.

In particular, two types of nano-scale MOF crystals can be produced by this method. Nano-scale metal organic framework crystal embodiments of the invention form particles that have relatively lower specific surface area and are not agglomerated, or have relatively higher specific surface area and are loosely agglomerated. Loosely agglomerated materials tend to re-disperse well in typical solvents while more tightly agglomerated materials, herein referred to as particulates, tend to re-disperse poorly and settle out of common solvents. The difference in specific surface area is expressed in relative terms rather than absolute terms because the specific surface area of a given MOF depends upon the design of the composition.

Metal organic framework crystals are important to the development of mixed matrix membranes, which require small particulate crystal material for incorporation into the nano-selective layer of the asymmetric membrane structure of the mixed matrix membrane. The discrete or loosely agglomerated particles formed by the method disclosed herein are particularly suited for such use.

Metal organic frameworks have similarities with zeolites. For example, synthesis conditions are similar and result in good yields. Both products are crystalline, and reactant conditions theoretically can be controlled to obtain specific hydrophilicity and acidity (or hydrophobicity and basicity).

However, metal organic frameworks are different from zeolites in important ways. Metal organic frameworks are less thermally stable than zeolites, with degradation typically occurring at a temperature of about 450° C. However, metal organic frameworks have much higher specific surface area and pore volume (both mesoporosity and microporosity). The structure of metal organic frameworks provides more unobstructed gas diffusion paths. Importantly, metal organic frameworks have many more potential combinations of metal-containing building units and linkers, and linkers can incorporate functionalities into the framework.

The following table presents a brief comparison of NaX, sodium X-type zeolite, and a prototypical MOF, the zinc terephthalate, MOF-5. The table illustrates the superior properties and characteristics of the metal organic framework as compared with the zeolite.

| | SSA, | Crystal | | | | CO₂ heat |
|---|---|---|---|---|---|---|
| | sq | density, | % free | Pore size, | Stability, | adsorption, |
| Material | m/g | g/cc | volume | Angstroms | ° C. | kJ/mol |
| NaX | 700 | 1.44 | 49 | 7.4 | >700 | 50 |
| zeolite | | | | | | |
| MOF-5 | 3800 | 0.62 | 79 | 12 | 400 | 15 |

The compositions that are used herein to synthesize the metal organic framework will be described, and then the method by which the metal organic framework crystals are synthesized will be set forth. Then, the properties and characteristics will be described.

An embodiment of the invention is directed to coordination polymers comprising metal-containing building units connected with linkers. The linkers partially or fully compensate for the ionic charges of the metal ions. The inventors have discovered that it is possible to include materials that have not previously been incorporated into nano-metal organic framework crystals. The inventors have discovered that both different metal-containing building units containing different metal ions and different linkers can be incorporated into nano-metal organic framework crystals.

Metal-containing building units include metal ions, metal ion clusters, chains of metal ions and metal clusters and similar so-called structural building units (SBUs). Such SBUs may include other elements such as oxygen, nitrogen, phosphorus, sulfur, a halogen, or other non-metals.

Metal ions are ions of a metal selected from the group consisting of Groups 1 through 16 of the Periodic Table, as those groups are defined by IUPAC, including the lanthanides and the actinides, and blends thereof. Metal ions have any valence the metal can exhibit.

The inventors have discovered that nano-scale metal organic framework crystals can be made with metal-containing SBUs different from those commonly used in MOF compositions.

Typically, a metal is selected from the group consisting of the transition metals, the alkaline earth metals, and blends thereof. More typically, metal is selected from the group consisting of magnesium, nickel, cobalt, copper, zinc, aluminum, and blends thereof. More typically, therefore, metal ions are selected from the group consisting of Mg⁺⁺, Ni⁺⁺, Co⁺⁺, Zn⁺⁺, Cu⁺⁺, Al³⁺, and blends thereof.

Linkers comprise organic bidentate, tridentate, tetradentate, or more generally, polydentate compounds that serve as ligands between metal-containing building units. In accordance with embodiments of the invention, organic polydentate compounds are compounds that are capable of coordinating the metal-containing building units. Typically, the organic polydentate compounds have moieties that bond with the metal-containing building units. More typically, the organic polydentate compounds have moieties that coordinate with metal-containing building units having metal ions selected from the group consisting of magnesium, nickel, cobalt, copper, zinc, aluminum, and blends thereof. Most typically, therefore, the organic polydentate compounds have moieties that coordinate with metal-containing building units having metal ions selected from the group consisting of Mg⁺⁺, Ni⁺⁺, Co⁺⁺, Zn⁺⁺, Cu⁺⁺, Al³⁺, and blends thereof.

In accordance with embodiments of the invention, linkers are selected from the group consisting of neutral organic ligands, anionic organic ligands, and cationic organic ligands. Typically, linker is selected from the group consisting of neutral organic liquids, anionic organic ligands, and blends thereof.

Neutral organic ligands include substituted and unsubstituted cyclic and polycyclic compounds containing heteroatoms and tetracyanoethylene. Neutral organic ligands typically have a heteroatom in the cyclic ring(s) or are substituted with pendant moieties, such as O,O⁻ bonded to N in a cyclic ring, and CN. Heteroatoms are selected from the group consisting of nitrogen, oxygen, and blends thereof. Typical neutral bidentate amine linkers include 4,4′-bispyridine (bipy), 1,2-bis(4-pyridyl)ethane (bpe), and 1,4-diazabicyclo[2.2.2]octane (dabco).

Anionic organic ligands include ionic forms of 2-cyano-malononitrile; dicyanamide; 2-oxo-propionic acid; but-2-enedioic acid; 2,5-deoxido, 4-benzene dicarboxylic acid; and substituted cyclic and polycyclic compounds substituted with pendant acidic moieties. The cyclic moiety may contain a heteroatom, typically nitrogen. Often, these compounds are dicarboxylic acids of benzene, naphthalene, pyridine, and quinoline compounds. Typically, anionic organic ligand is selected from the group consisting of 1,4-benzene dicarboxylic acid (H₂BDC), 1,3,5-benzene tricarboxylic acid (H₃BTC), 1,2,4,5-benzene tetracarboxylic acid (H₄BTeC), and blends thereof. The ionic forms of these identified compounds are identified as BDC, BTC, and BTeC, respectively.

Cationic organic ligands include protonated polyamines and related species.

Embodiments of the invention are directed to a method for making metal organic frameworks. The inventors have discovered a method for making metal organic frameworks that reduces the amounts of reactants and solvents required. The inventors also have discovered that it is possible to control the properties and characteristics of metal organic frameworks by controlling operating conditions during preparation of the metal organic framework.

Embodiments of the invention are directed to a method for preparing metal organic frameworks by reacting metal-containing building units with linkers in solvent to form metal organic framework compounds that have properties and characteristics different from known metal organic framework compounds. Although some metal organic framework embodiments of the invention have the same chemical formula as known metal organic frameworks, the properties and characteristics of metal organic framework embodiments of the invention are different from the properties and characteristics of known metal organic frameworks.

In embodiments of the invention, metal organic framework is prepared by adding a basic compound to a solution of metal salt and linker under vigorous stirring at ambient temperature for a period sufficient to yield metal organic framework crystals having a particle size less than about 100 nm. Thus, the metal organic framework crystals also are called nano-scale metal organic framework crystals, or nano-metal organic framework crystals. The morphology of nano-metal organic framework crystals thus produced is related to the concentration of reagents, i.e., metal salt and linker, in the reaction solution. Metal organic framework crystals produced at lower reagent concentration yield discrete particles having relatively lower specific surface area, whereas higher reagent concentration yields metal organic framework crystals that are loosely agglomerated particles having relatively higher specific surface area.

Metal salt used in embodiments of the invention is a salt of the metal ion to be incorporated into the metal organic framework crystals. The counter-ion is selected to provide a salt of sufficient solubility in the solvent that does not interfere with the reaction, for example by formation of a precipitate with other reactants, and is economically supplied. Typically, the counter-ion is selected from the group consisting of nitrate, acetate, formate, sulfate, perchlorate, cyanide, azide, the halides, and blends thereof. More typically, the counter-ion is nitrate.

Thus, metal salts typically used in embodiments of the invention are selected from the group consisting of magnesium, nickel, cobalt, zinc, copper, and aluminum nitrate, and blends thereof. However, other metals, including all transition metal ions, and other anions, such as those listed above, can be utilized effectively by a skilled practitioner as is, and in mixtures and blends. For the salts that may exist as a hydrate, any number of hydrating water molecules may be present.

The solvent is selected to solubilize or suspend both the metal salt and the linker and to provide a suitable fluid in which the reaction takes place to form solid metal organic framework crystals and which is a solvent, when the reaction is complete, for unreacted salt and linker, remaining reactant moieties, such as the metal counter-ion, and any additives. The inventors have discovered that metal organic framework crystals formed from mixed solvent systems have more uniform particle size than crystals formed from pure solvent systems. Therefore, in embodiments of the invention, the solvent typically is a blend of solvents.

Solvent in embodiments of the invention is selected from the group consisting of formamides, sulfoxides, nitriles, esters, amines, ethers, ketones, aromatics, aliphatics, and water. Typically, solvent is selected from the group consisting of ammonia, hexane, benzene, toluene, xylene, chlorobenzene, nitrobenzene, naphthalene, thiophene, pyridine, acetone, 1,2-dichloroethane, methylenechloride, tetrahydrofuran, N,N-dimethyl formamide, N,N-diethyl formamide, methanol, ethanol, propanol, alcohols, dimethylsulfoxide, choloroform, bromoform, dibromomethane, iodoform, diiodomethane, halogenated organic solvents, N,N-dimethylacetamide, N,N-diethylacetamide, 1-methyl-2-pyrrolidinone, and amide-containing solvents. More typically, solvent is selected from the group consisting of blends of dimethyl formamide, N-methylpyrrolidone, chlorobenzene, ethanol, and water. Even more typically, solvent is a blend of solvents.

The inventors have discovered that addition of an additive to the reaction solution before addition of the basic reactant improves product uniformity. Thus, the particle size is more consistent, and the degree of agglomerization is reduced for the particles that exhibit higher specific surface area. In accordance with embodiments of the invention, additives are from the class of surfactants and include ether compounds typically comprising straight-chain paraffins concatenated with plural ether moieties, typically ethylene glycol, and capped with a hydroxyl moiety. Typically, additive is selected from the group consisting of Brij® surfactants, similar straight-chain paraffins concatenated with plural ether moieties and capped with a hydroxyl moiety, and blends thereof. The chemical formulas for such compounds often are expressed in the form CₓE_{y}, wherein x is the number of carbon atoms in the straight chain paraffin moiety and y is the number of ethylene glycol moieties concatenated with the paraffin moiety. For example, decaethyleneglycol monododecylether is abbreviated C₁₂E₁₀, and diethylenegylcol monohexylether is abbreviated C₆E₂. Other examples include Brij30®, which is C₁₂E₄ and also is known as polyoxyethylene (4) lauryl ether; Brij56®, which is C₁₆E₁₀; and Brij72®, which is C₁₈E₂.

More typically, additive is selected from the group consisting of Brij30®, Brij56®, Brij72®, C₆E₂, C₁₂E₁₀, and blends thereof.

Basic reactant then is added. Embodiments of the invention are directed to organic basic reactants that are capable of deprotonating the organic polydentate compound. Typically, the basic reactant is selected from the group consisting of triethylamine, tetraalkylammonium hydroxides, and blends thereof. The alkyl moiety in the tetraalkylammonium hydroxides includes, for example, methyl, ethyl, propyl, and butyl, and blends thereof.

The solution of salt and linker is formed by dissolving or suspending linker in solvent at ambient, or room, temperature, typically between about 15° C. and about 30° C., more typically between about 20° C. and about 25° C. Then, acid is added with continuing stirring. While this order of addition is typical, the order of addition of these reactants can be changed, and can be in any order.

Additive then may be added to the solution of salt and linker in solvent and the mixture is stirred rapidly. The stirring is sufficient to thoroughly mix the components. Acceptable metal organic framework crystals product can be produced without additive. Uniformity is, however, improved by addition of additive to the reaction fluid. Then, base compound is added to the solution while continuing vigorous stirring for a period sufficient to effect the reaction.

The inventors have discovered that, when carried out at ambient temperature, the reaction is sufficiently fast so as to be commercially practical, and typically is completed within about 20 minutes to about 4 hours, more typically between about 25 minutes to about 2 hours, and most typically between about 30 minutes to about 60 minutes.

After the period allotted for reaction, metal organic framework crystals are separately recovered from the reaction fluids, typically by filtration or centrifugation. The resultant metal organic framework crystals embodiments of the invention then are washed, dried, and otherwise treated in known ways to obtain uncontaminated particles.

Embodiments of the invention are directed to reactions in which the total molality of metal-containing structural building unit and linker reactants in solvent is at least about 0.03 M, typically at least about 0.05 M, and more typically at least about 0.08 M. The total reactant concentration often ranges from about 0.03 M to about 0.15 M, typically between about 0.05 M to about 0.15 M, and more typically between about 0.08 M and about 0.15 M, and most typically between about 0.1 M and about 0.14 M. The inventors have discovered that increasing the concentration of reactants in solvent produces metal organic framework crystals having higher specific surface area and porosity. However, reactant concentration above about 0.15 M does not further increase surface area and porosity.

As used herein, lower specific surface area is defined as specific surface area cannot be defined on an objective basis, because nano-metal organic framework crystals have different target properties and characteristics that are related to the identities of the metals, the linkers, and any additives present in the reaction solution. However, generally, specific surface area of higher specific surface area product is at least about 50 percent greater than, and typically about 100 percent greater than, the specific surface area of lower specific surface area product. Higher specific surface area materials tend to have greater than 50 percent of their porosity expressed as mesoporosity, or, expressed another way, greater than 50 percent of their surface area as external surface area. External surface area is surface not within the micropores of the MOF.

Typically, the concentration of metal and linker reactants required to approximately double the specific surface area and produce higher specific surface area material is between about double and about four times the concentration of lower specific surface area nano-metal organic framework crystals. Examples of these relationships are set forth below. With the guidance provided herein, the skilled practitioner will be able to produce nano-metal organic framework crystals having pre-selected properties and characteristics. In particular, embodiments of the invention make it possible to produce high specific surface area metal organic framework crystals without additional steps, such as addition of hydrogen peroxide or other compounds.

The inventors have discovered also that mesoporosity and microporosity are related to the concentration of metal and linker reactants in solvent. Mesoporosity is defined as the pore volume between metal organic framework crystals in a particle, and microporosity is defined as the pore volume within the structure of the crystal. These are standard definitions known to the skilled practitioner. The inventors have discovered that both mesoporosity and microporosity increase with increase in reactant concentration. Depending upon the identities of the metal and of the linkers, the mesoporosity increases about 25 percent and microporosity increases about 50 percent with a doubling of reactant concentration. Metal organic framework crystals comprising nickel and DOBDC exhibit this relationship, as can be seen in the examples below. However, other metals, such as magnesium and cobalt, yield about a 50 percent increase in mesoporosity and about a quadrupled microporosity with quadrupling reactant concentration. With the guidance provided herein, the skilled practitioner can determine how to produce metal organic framework crystals having pre-selected properties and characteristics.

The inventors also have discovered that significantly short reaction times can be obtained at significantly lower ratio of basic compound to acid function. Acid function relates to the number of acid moieties on an acid. Thus, the ration of base to acid function is calculated as (moles of base)/[(moles of acid) times (number of acid moieties per molecule)]. Embodiments of the invention are directed to methods in which the ratio of base to acid function, which can be expressed as base/COOH, is between about 0.15:1 and about 3.5:1, typically between about 0.20:1 and about 2.2:1, more typically from about 0.20:1 to less than 2:1, and most typically, between about 0.25:1 and about 1.75:1. Base/COOH can be in the range of about 0.25:1 to less than 1:1 in embodiments of the invention.

Typical embodiments of the invention are summarized in the following table. The table identifies metals, base/acid ration, reactant concentrations, solvent systems, and if any is used, additives that typically are used in embodiments of the invention.

| | | | Conc. of | | |
|---|---|---|---|---|---|
| | | Base/Acid | Metal + | Solvent | |
| Metal | Structure | function | Linker, M | system | Additive |
| Cu | HKUST-1 | 2.2 | 0.07-0.1 | DMF | Brij30 ®, none |
| Cu | HKUST-1 | 0.25-2.2 | 0.07-0.1 | DMF, | Brij30 ®, none |
| | | | | EtOH, H₂O | |
| Al | MIL-53 | 2.2 | 0.13 | DMF, | none |
| | | | | EtOH, H₂O | |
| Zn | DOBDC | 2.2 | 0.03-0.14 | DMF, | none, Brij30 ® |
| | | | | H₂O | |
| Co | DOBDC | 2.2 | 0.03-0.14 | DMF, | Brij30 ®, |
| | | | | EtOH, H₂O | Brij56 ®, |
| | | | | | C₆E_{2,} C₁₂E₁₀ |
| Ni | DOBDC | 2.2 | 0.03-0.14 | DMF, | Brij30 ® |
| | | | | EtOH, H₂O | |
| Mg | DOBDC | 2.2 | 0.03-0.14 | DMF, | Brij30 ® |
| | | | | EtOH, H₂O | |

More typically, triethylamine is used as the base compound in embodiments of the invention.

Embodiments of the invention are directed to metal organic framework crystals having a particle size less than about 100 nm, typically between about 1 nm and about 70 nm, more typically between about 2 nm and about 60 nm, and most typically between about 3 nm and 50 nm.

The following examples should be considered illustrative of embodiments of the invention, and should not be used to limit the invention in any way.

### EXAMPLES

Nano-metal organic framework crystals were made in accordance with the method disclosed herein. In each case, the identified linker was dissolved in the solvent with additive, if any. Then, metal salt was added, and the combination was stirred vigorously at room temperature, between about 20° C. and 30° C. Then triethylamine was added to achieve the identified molar ratio of base to acid. Various properties and characteristics of these products were determined.

The reactants and identity of the resultant nano-metal organic framework crystals are set forth for each example in the following table:

| | | | | Conc. | | |
|---|---|---|---|---|---|---|
| | | | | of | | |
| Ex- | | | | Metal + | | |
| am- | | MOF | TEA/ | Linker, | Solvent | |
| ple | Metal Salt | Type | COOH | M | system | Additive |
| 1-1 | Cu(NO₃)₂ | HKUST-1 | 2.2 | 0.07 | DMF | None |
| 1-2 | Cu(NO₃)₂ | HKUST-1 | 2.2 | 0.07 | DMF | Brij30 ® |
| 1-3 | Cu(NO₃)₂ | HKUST-1 | 2.2 | 0.1 | DMF | None |
| 1-4 | Cu(NO₃)₂ | HKUST-1 | 2.2 | 0.1 | DMF | Brij30 ® |
| 2-1 | Cu(NO₃)₂ | HKUST-1 | 2.2 | 0.1 | DMF, | None |
| | | | | | EtOH, W | |
| 2-2 | Cu(NO₃)₂ | HKUST-1 | 2.2 | 0.1 | DMF, | Brij30 ® |
| | | | | | EtOH, W | |
| 2-3 | Cu(NO₃)₂ | HKUST-1 | 1.5 | 0.1 | DMF, | Brij30 ® |
| | | | | | EtOH, W | |
| 2-4 | Cu(NO₃)₂ | HKUST-1 | 1.0 | 0.1 | DMF, | Brij30 ® |
| | | | | | EtOH, W | |
| 2-5 | Cu(NO₃)₂ | HKUST-1 | 0.5 | 0.1 | DMF, | Brij30 ® |
| | | | | | EtOH, W | |
| 2-6 | Cu(NO₃)₂ | HKUST-1 | 0.25 | 0.1 | DMF, | Brij30 ® |
| | | | | | EtOH, W | |
| 3 | Al(NO₃)₃ | MIL-53 | 2.2 | 0.13 | DMF, | None |
| | | | | | EtOH, W | |
| 4-1 | Zn(NO₃)₂ | DOBDC | 2.2 | 0.035 | DMF, W | None |
| 4-2 | Zn(NO₃)₂ | DOBDC | 2.2 | 0.035 | DMF, W | Brij30 ® |
| 4-3 | Zn(NO₃)₂ | DOBDC | 2.2 | 0.14 | DMF, W | None |
| 4-4 | Zn(NO₃)₂ | DOBDC | 2.2 | 0.14 | DMF, W | Brij30 ® |
| 5-1 | Co(NO₃)₂ | DOBDC | 2.2 | 0.035 | DMF, | Brij30 ® |
| | | | | | EtOH, W | |
| 5-2 | Co(NO₃)₂ | DOBDC | 2.2 | 0.035 | DMF, | Brij56 ® |
| | | | | | EtOH, W | |
| 5-3 | Co(NO₃)₂ | DOBDC | 2.2 | 0.035 | DMF, | C₆E₂ |
| | | | | | EtOH, W | |
| 5-4 | Co(NO₃)₂ | DOBDC | 2.2 | 0.035 | DMF, | C₁₂E₁₀ |
| | | | | | EtOH, W | |
| 5-5 | Co(NO₃)₂ | DOBDC | 2.2 | 0.14 | DMF, | Brij30 ® |
| | | | | | EtOH, W | |
| 5-6 | Co(NO₃)₂ | DOBDC | 2.2 | 0.14 | DMF, | C₆E₂ |
| | | | | | EtOH, W | |
| 5-7 | Co(NO₃)₂ | DOBDC | 2.2 | 0.14 | DMF, | Brij56 ® |
| | | | | | EtOH, W | |
| 5-8 | Co(NO₃)₂ | DOBDC | 2.2 | 0.14 | DMF, | C₁₂E₁₀ |
| | | | | | EtOH, W | |
| 6-1 | Ni(NO₃)₂ | DOBDC | 2.2 | 0.035 | DMF, | Brij30 ® |
| | | | | | EtOH, W | |
| 6-2 | Ni(NO₃)₂ | DOBDC | 2.2 | 0.14 | DMF, | Brij30 ® |
| | | | | | EtOH, W | |
| 7-1 | Mg(NO₃)₂ | DOBDC | 2.2 | 0.035 | DMF, | Brij30 ® |
| | | | | | EtOH, W | |
| 7-2 | Mg(NO₃)₂ | DOBDC | 2.2 | 0.14 | DMF, | Brij30 ® |
| | | | | | EtOH, W | |

Note:
In the table, W means water.
Examples 4 through 7 also are known as M/DOBDC, where M = Co, Ni, Zn, and Mg, respectively. The structures of the identified compounds are well-known.

Various properties and characteristics of these compounds are illustrated in the drawing figures.

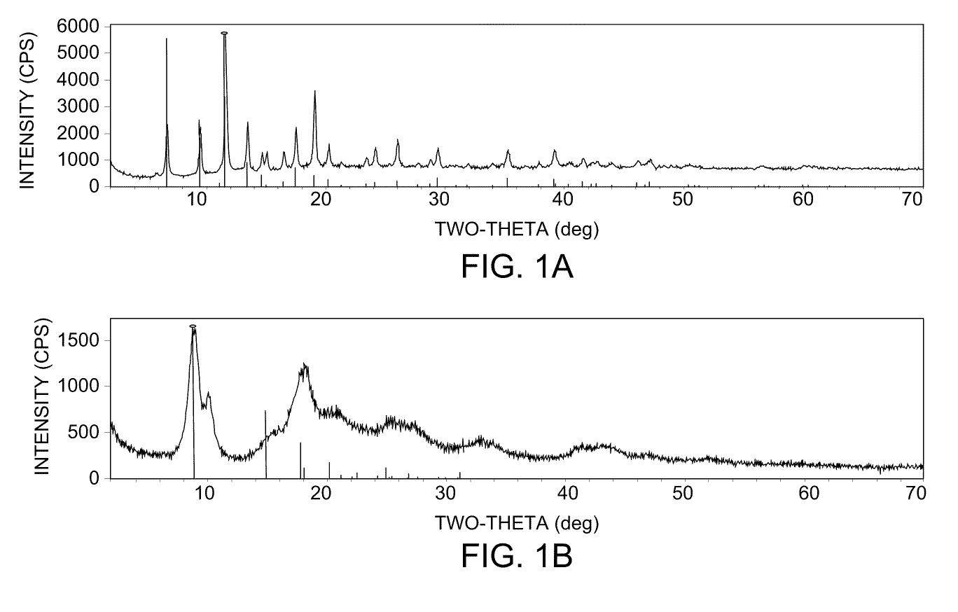

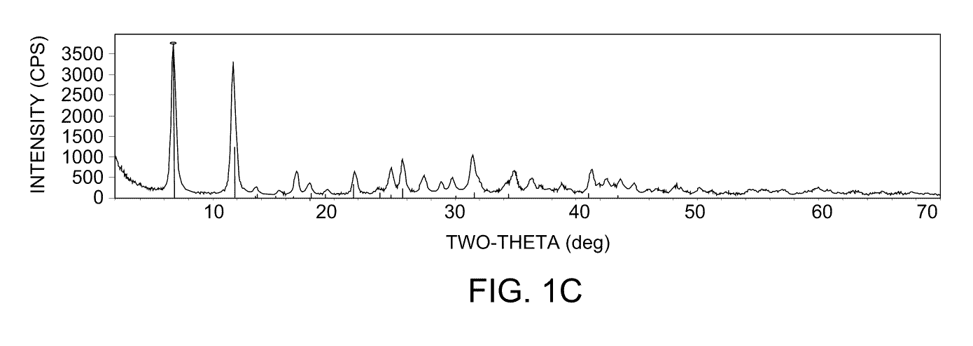

FIGS. 1A-1C illustrate extension of the technology in the form of addition of triethylamine to different MOF types. FIGS. 1A-1C are x-ray diffraction (XRD) patterns for the compositions of Examples 2-2, 3, and 4-3, respectively. The XRD patterns illustrate that the compounds have the expected structures.

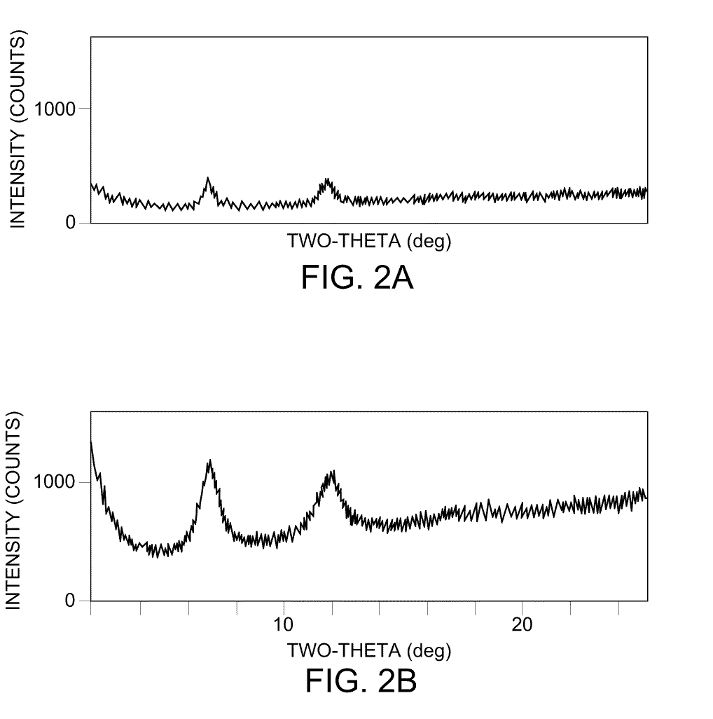

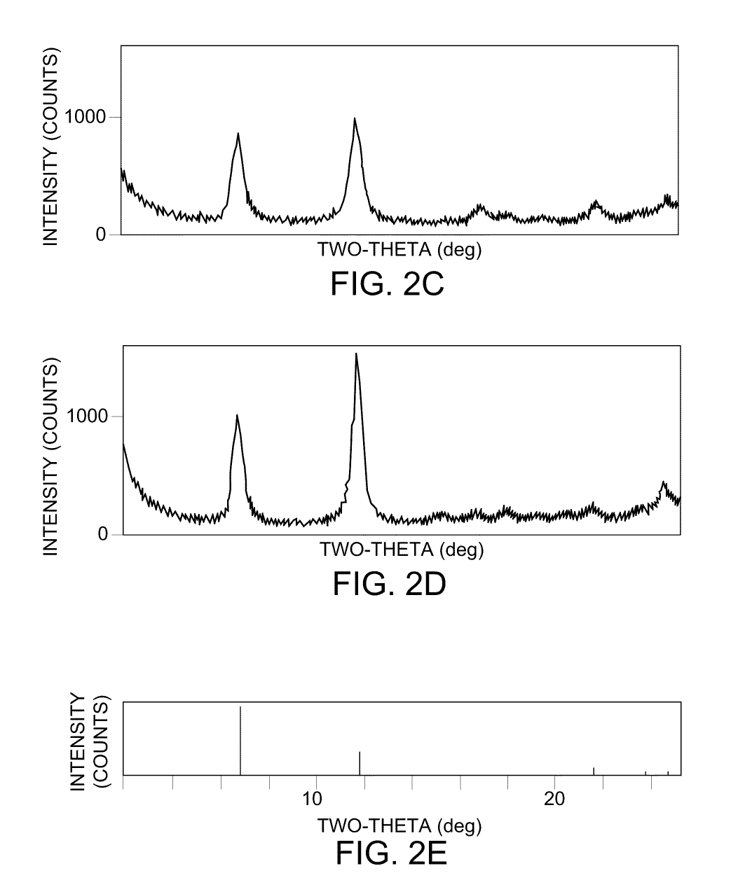

FIGS. 2A-2D illustrate the product of addition of triethylamine to DOBDC linker with cobalt, nickel, zinc, and magnesium metals, respectively. These Figs. are XRD patterns of the compositions of Examples 5-1, 6-1, 4-4, and 7-1, respectively. FIG. 2E is the calculated XRD pattern for M/DOBDC MOF's.

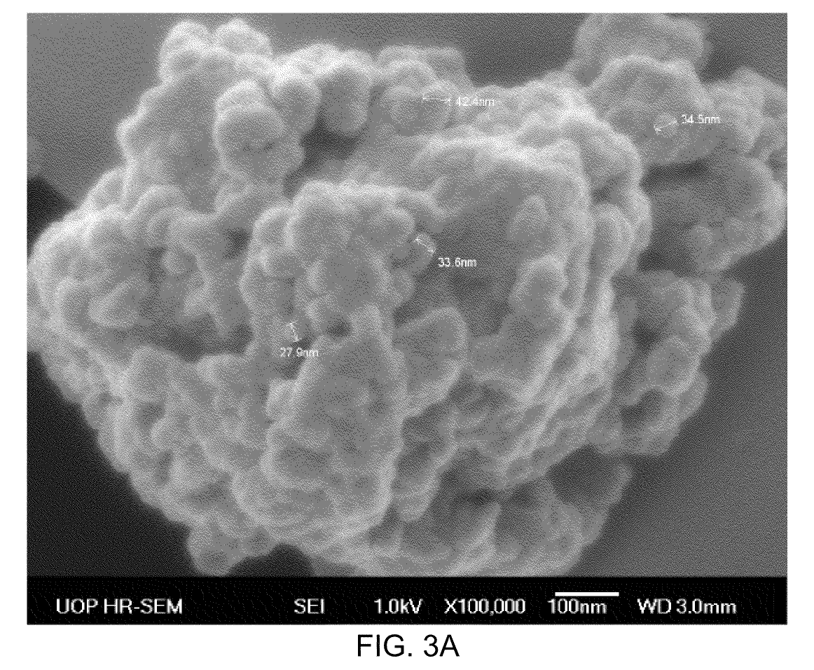

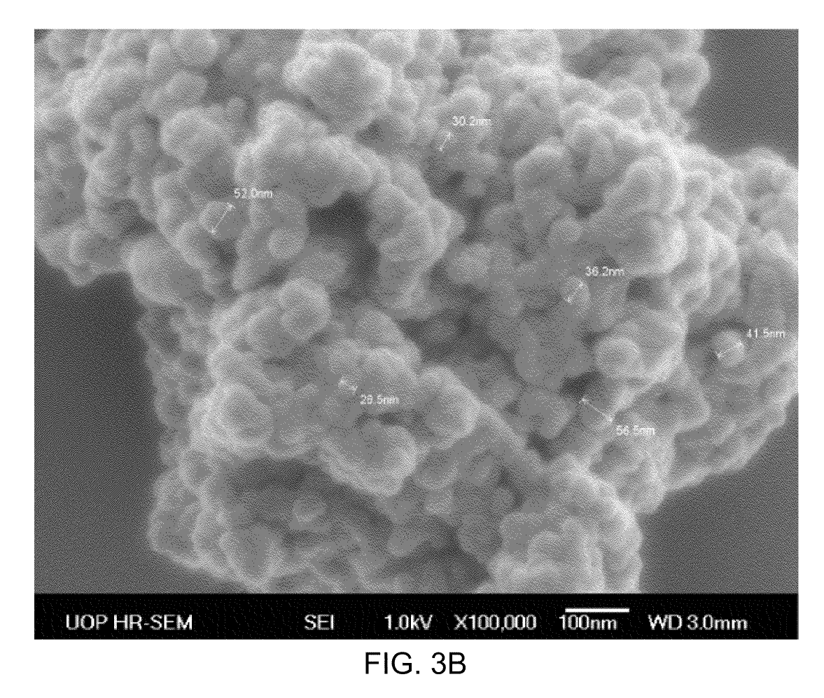

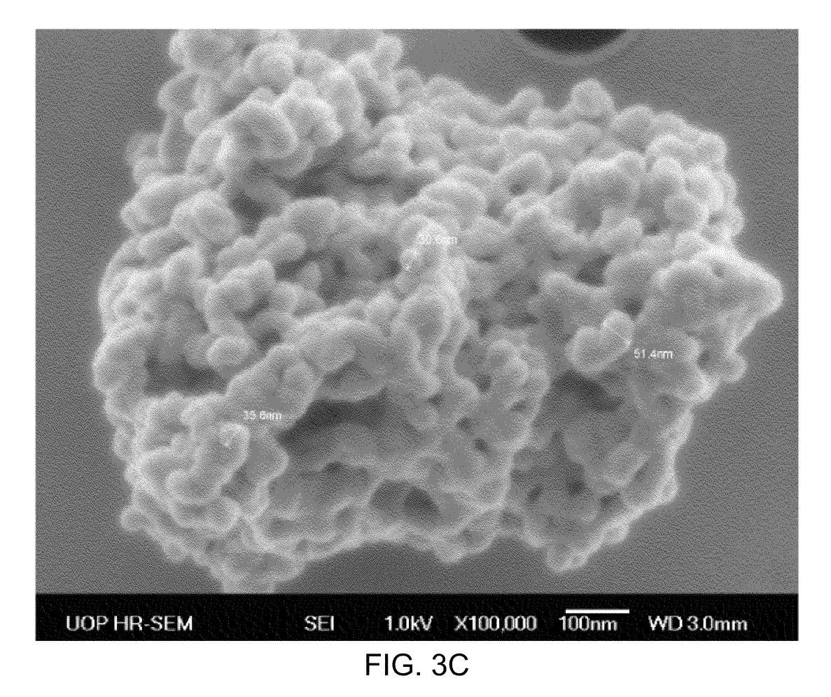

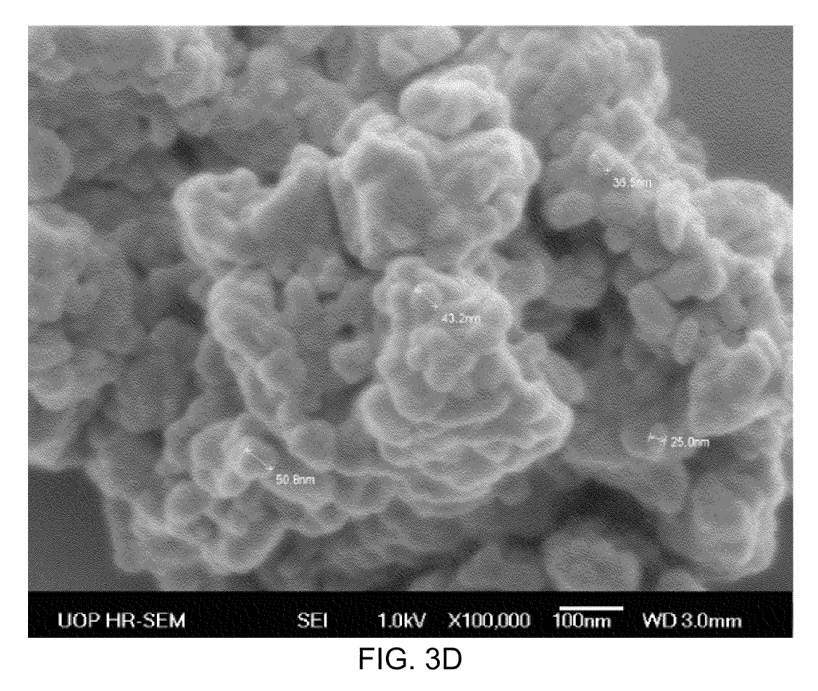

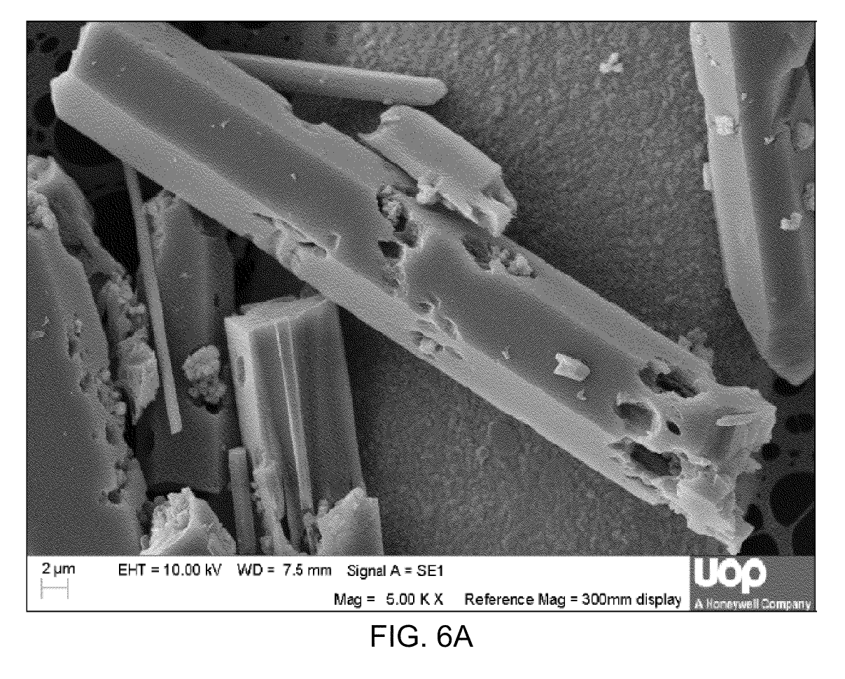

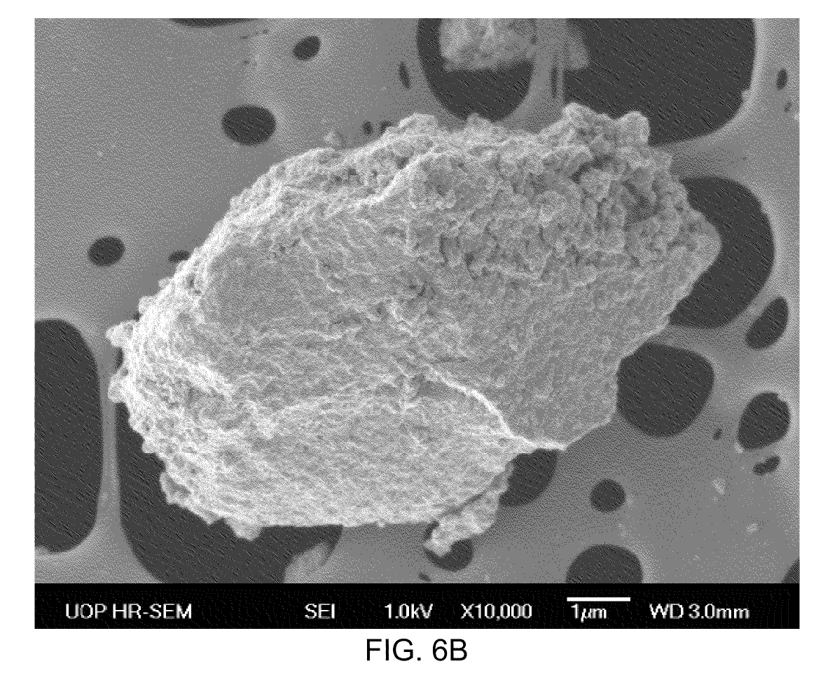

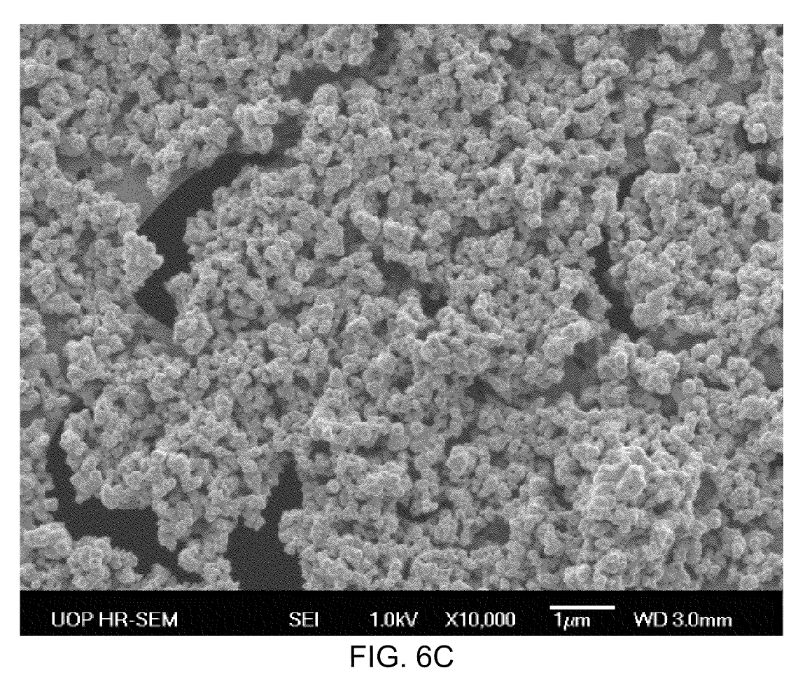

FIGS. 3A-3D are SEM depictions of each of the MOF compositions illustrated in FIGS. 2A-2D. These SEM depictions illustrate the nature of the MOF compositions, including in particular the size of representative particles. These images and experimental observations upon attempts to re-disperse these materials reveals that the materials are intermediate between “loosely agglomerated” (such as in FIG. 6C, below) and harder particulates (such as FIG. 6A, below).

For example, FIG. 3A identifies representative particle sizes of 27 nm, 33 nm, and 34.5 nm; FIG. 3B identifies particles of 26.5 nm, 36.2 nm, and 53 nm; FIG. 3C, 35 nm and 51 nm; and FIG. 3D, 25 nm and 56 nm.

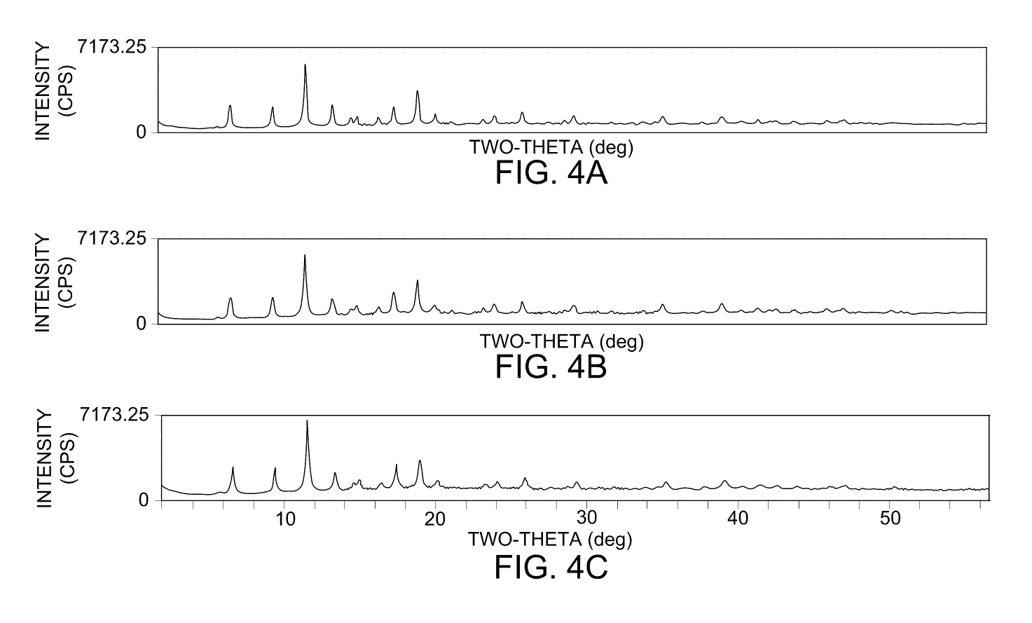

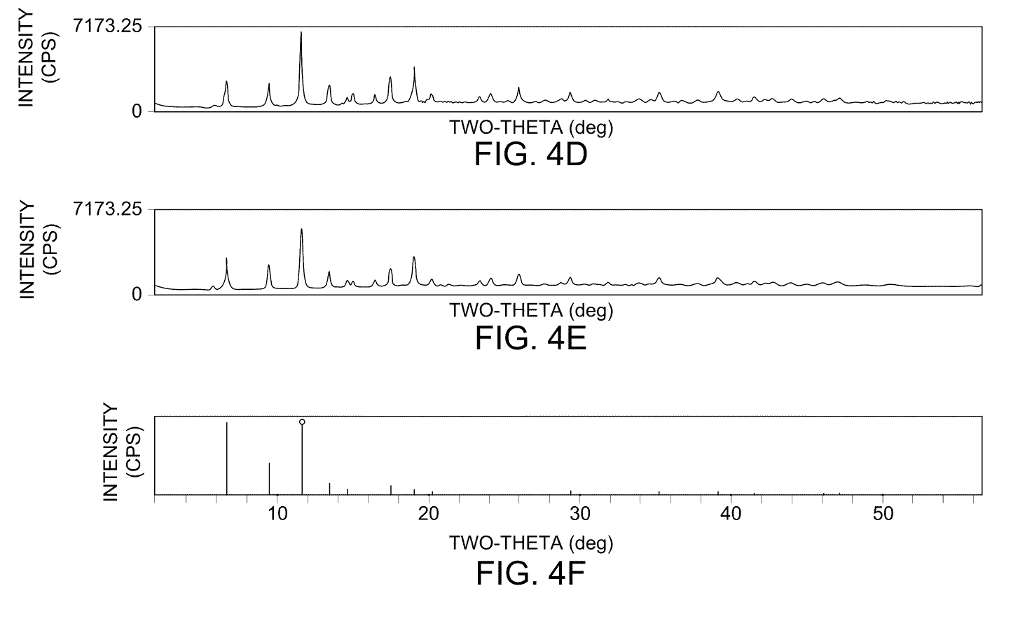

FIGS. 4A-4E illustrate the XRD patterns for compositions prepared in Example 2 at the identified TEA/Acid ratios of Examples 2-2, 2-3, 2-4, 2-5, and 2-6. The XRD patterns are essentially identical and compare favorably with the simulated XRD pattern, illustrating that the same composition was produced in each case. FIG. 4F is the calculated XRD pattern for HKUST-1.

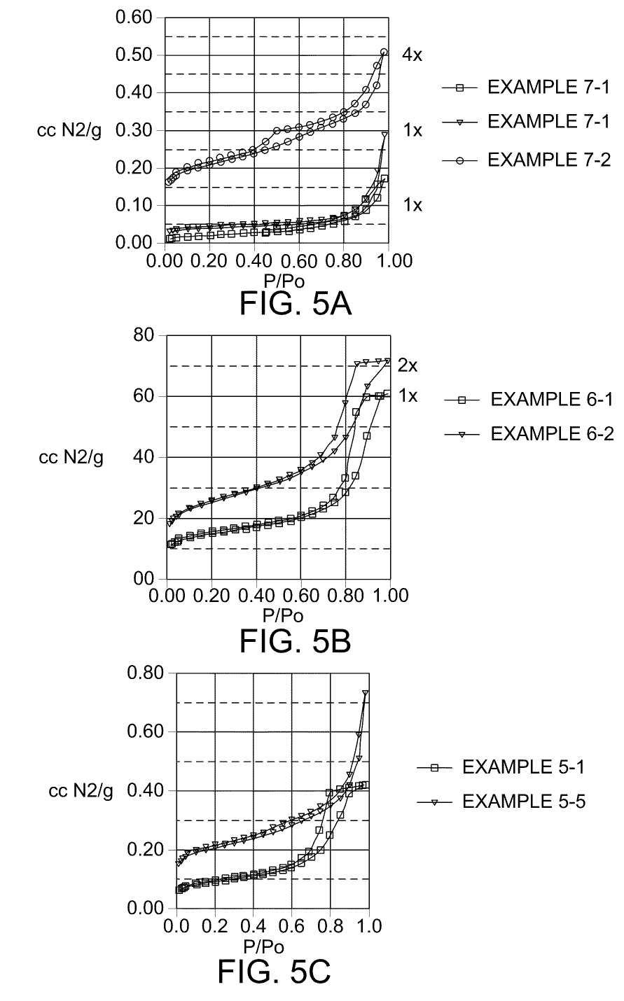

FIGS. 5A-5C illustrate the increased specific surface area, mesoporosity, and microporosity obtained by increasing reactant concentration. FIGS. 5A-5C are sorption/desorption curves for M/DOBDC compounds of examples 7-1 and 7-2, 6-1 and 6-2, and 5-1 and 5-5, respectively.

The following table summarizes properties and characteristics for these MOF compositions. The drawing figures and the data in the following table clearly illustrate the increased specific surface area, mesoporosity, and microporosity obtained by increasing reactant concentration.

| | Total | | | | Langmuir |
|---|---|---|---|---|---|
| | Pore | Micropore | Mesopore | BET specific | specific |
| Example | Volume | Volume | Volume | surface area | surface area |
| 7-1 | 0.288 | 0.025 | 0.263 | 85 | 126 |
| 7-2 | 0.510 | 0.107 | 0.403 | 442 | 653 |
| 6-1 | 0.609 | 0.077 | 0.531 | 320 | 477 |
| 6-2 | 0.720 | 0.117 | 0.603 | 545 | 814 |
| 5-1 | 0.422 | 0.024 | 0.398 | 202 | 304 |
| 5-5 | 0.738 | 0.096 | 0.643 | 439 | 652 |

FIGS. 6A-6C are SEM depictions of Co/DOBDC prepared by a previously known hydrothermal method (FIG. 6A) and Examples 5-4 (FIG. 6B) and 5-5 (FIG. 6C). As can be seen, at 5000× magnification, the hydrothermal method produces a rod-like product that appears to have little external porosity (mesoporosity). However, the products of the invention, illustrated at 10,000× magnification, are particulate product 6B obtained at relatively low reactant concentration and the rather loosely agglomerated morphology of 6C obtained at high reactant concentration.

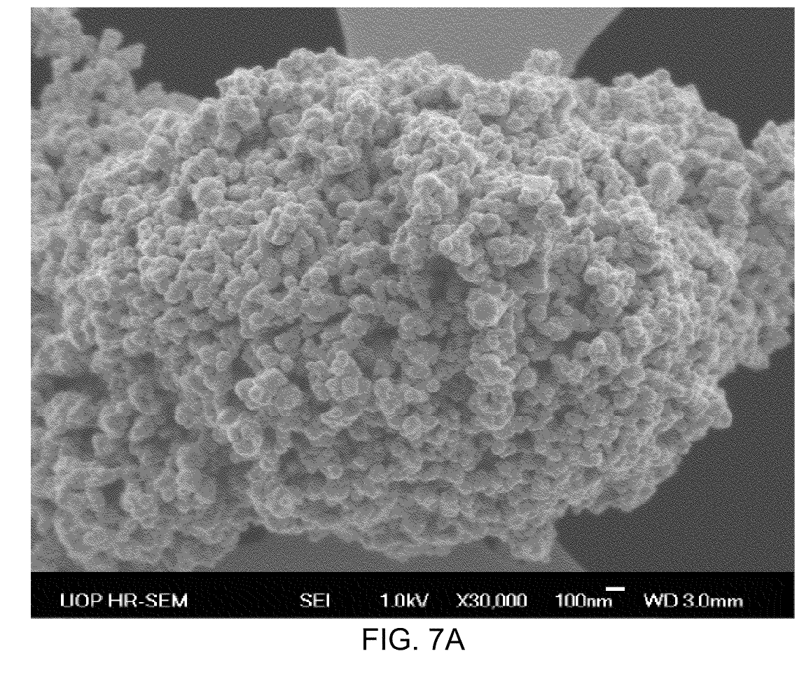

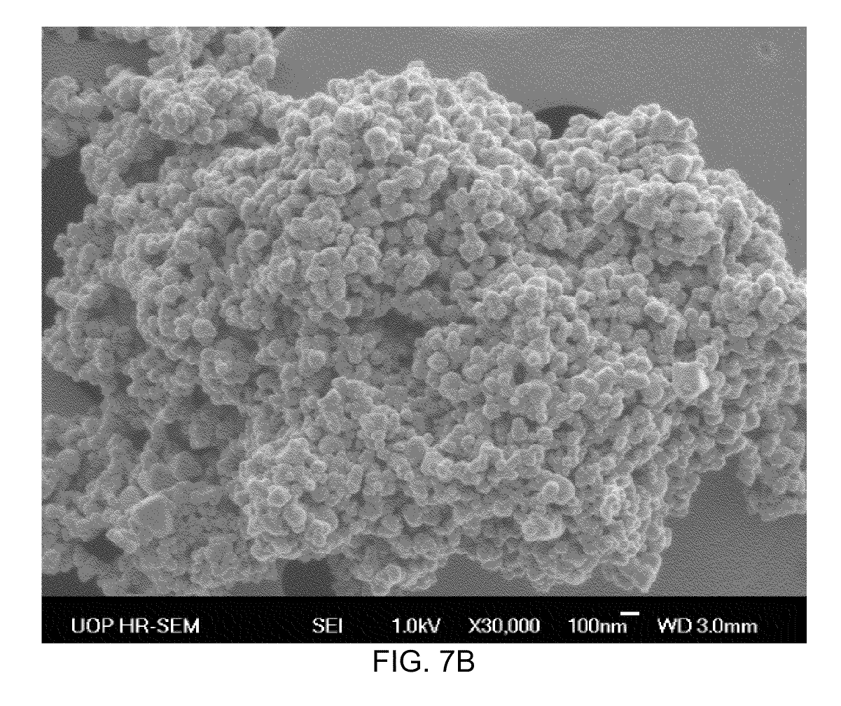

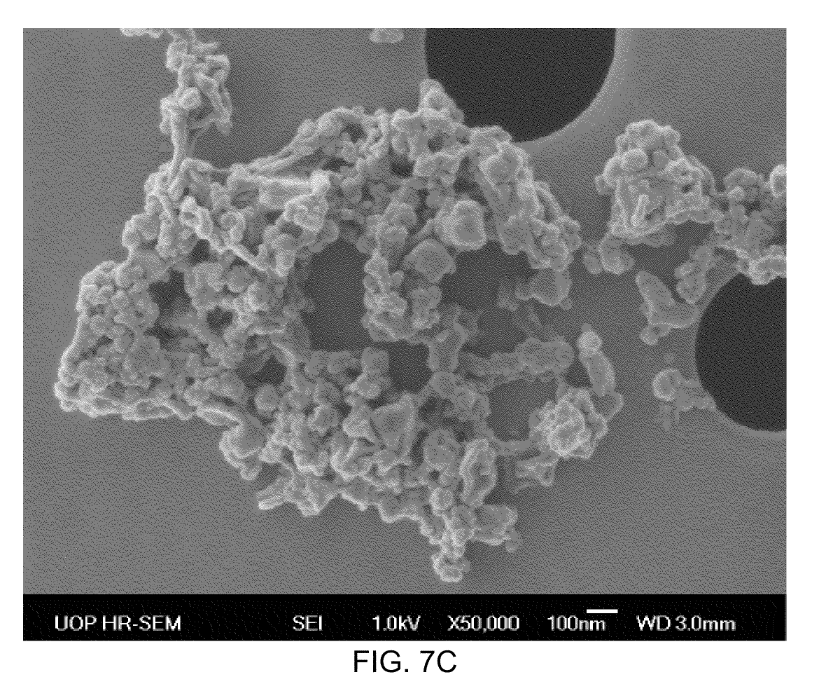

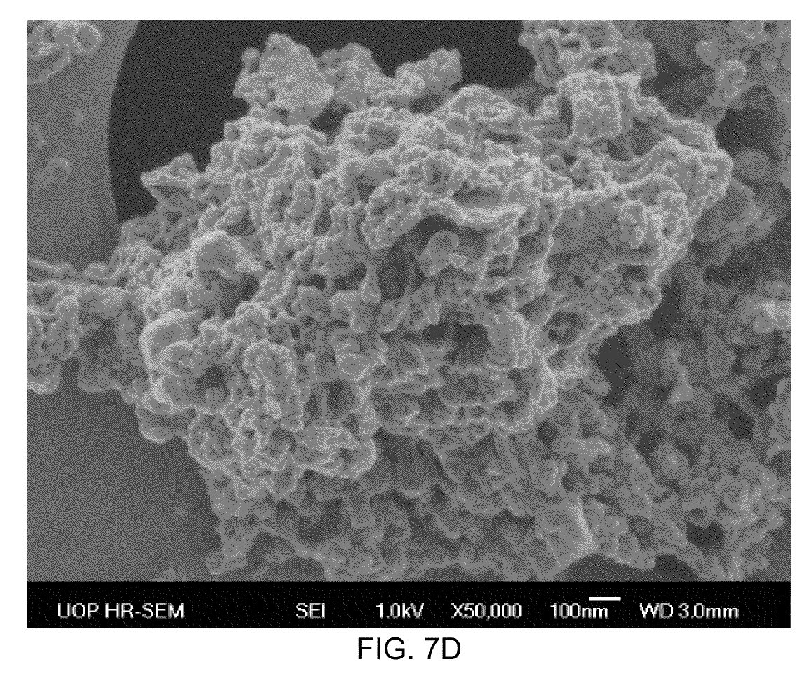

FIGS. 7A-7D illustrate the feature of the invention whereby HKUST-1 made in accordance with embodiments of the invention was more uniform when made with additive than product made without additive. FIGS. 7A and 7B depict HKUST-1 of Example 2-2, show essentially identically sized and shaped crystallites within a particulate. FIGS. 7C and 7D depict HKUST-1 made without additive, in accordance with example 2-1. Here the crystallites are of various sizes and morphologies.

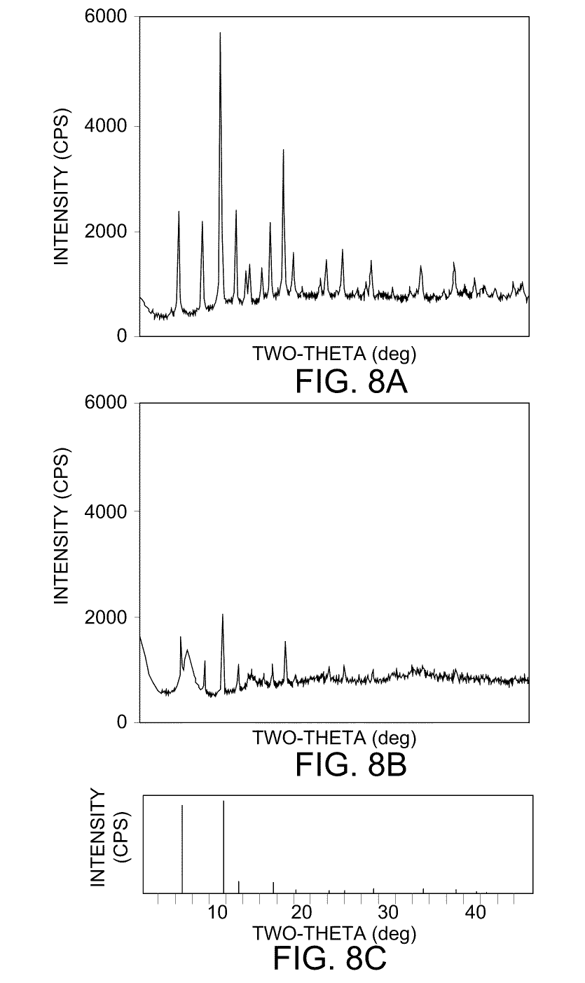

The XRD patterns for these compounds of FIGS. 7A-7D are set forth in FIGS. 8A (Brij30®) and 8B (no additive). These traces illustrate that the intensity, and hence the consistency of product, was higher for product made with additive. FIG. 8C is the calculated XRD pattern for HKUST-1. FIG. 8A compares more favorably with FIG. 8C than does FIG. 8B, which contains a broad peak of unidentifiable material as well.

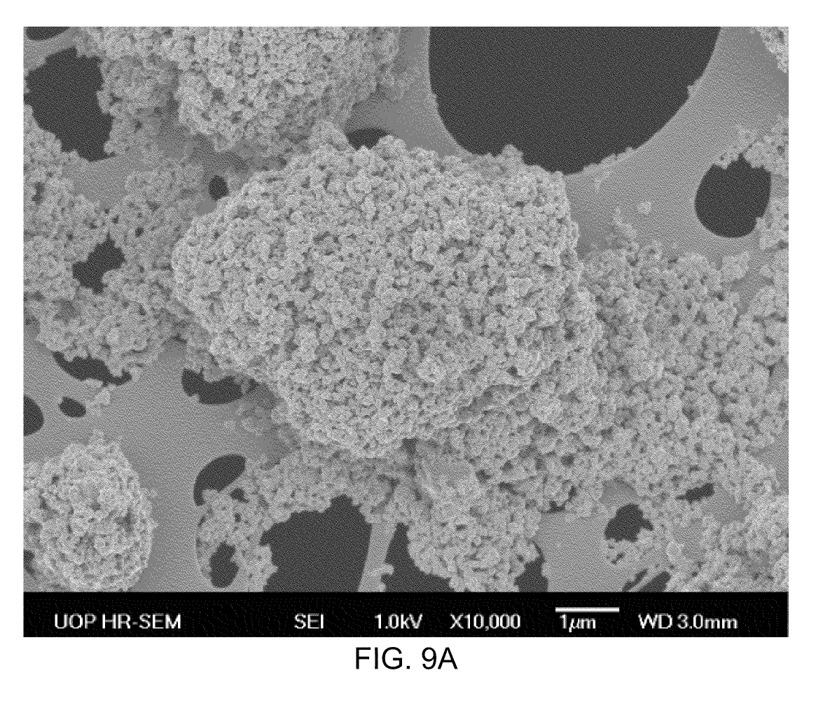

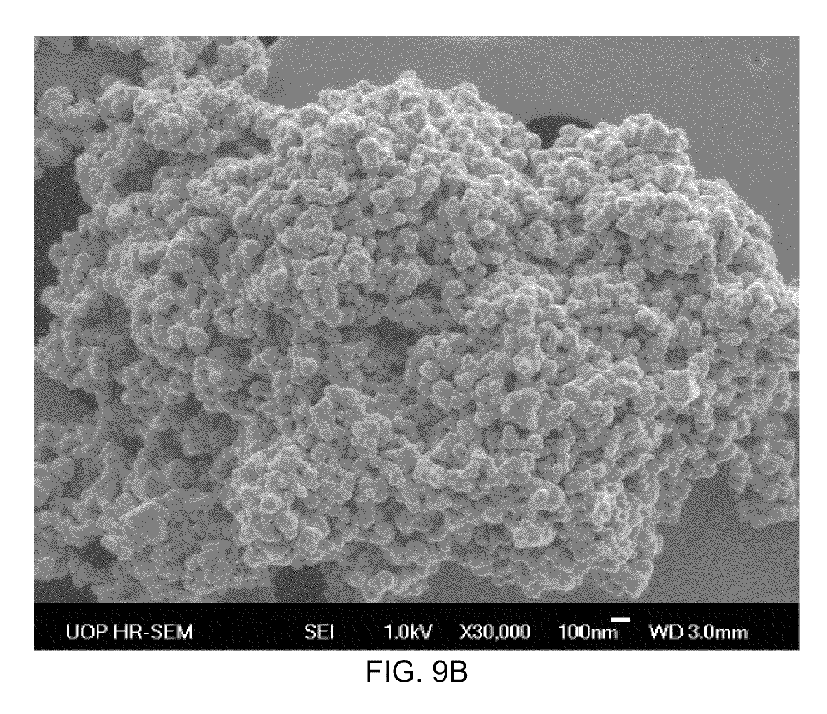

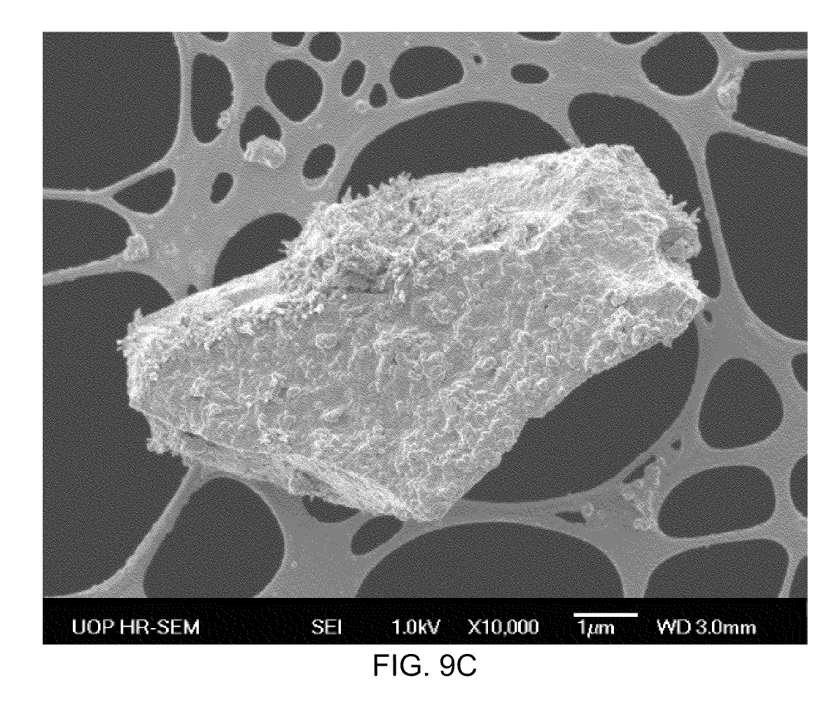

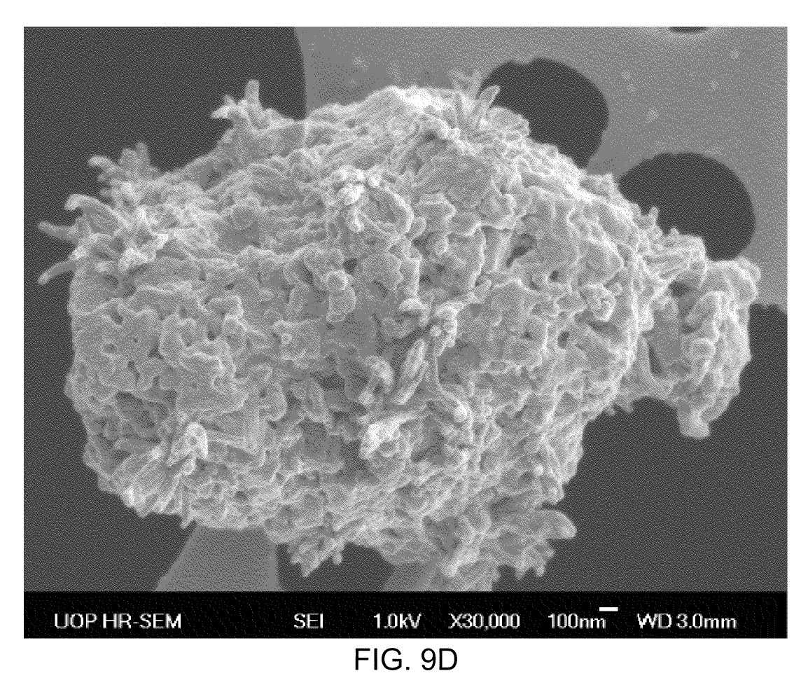

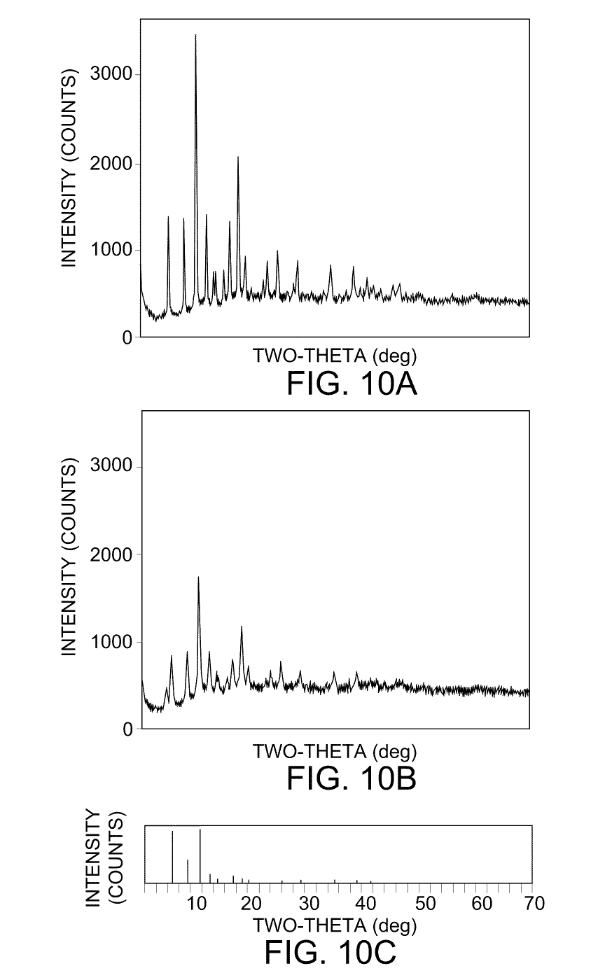

FIGS. 9A-9D and 10A and 10B illustrate the greater uniformity of Example 2-2, using mixed solvent (FIGS. 9A, 9B, and 10A) as compared with Example 1-4, using only DMF solvent (FIGS. 9C, 9D, and 10B). Both examples were made in the presence of Brij30® additive. The crystallites are more uniform when mixed solvent was used, as can be seen for the more favorable comparison between FIGS. 10A and 10C. FIG. 10C is the calculated XRD pattern for HKUST-1.

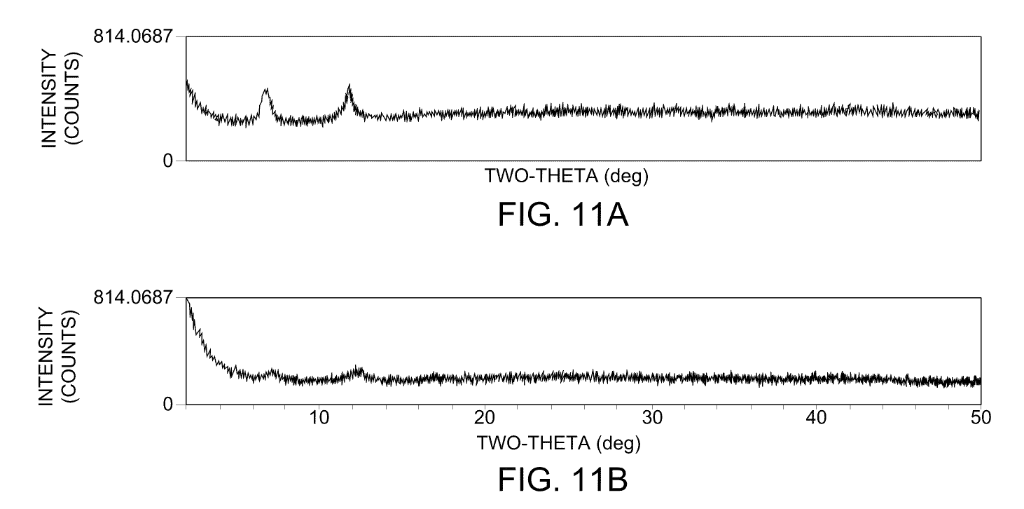

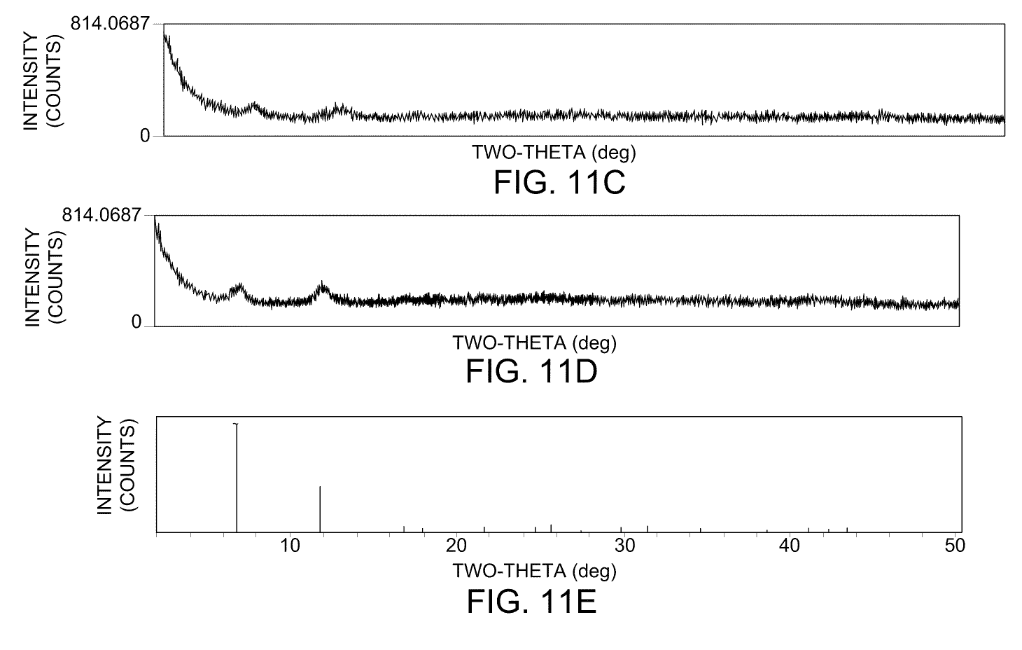

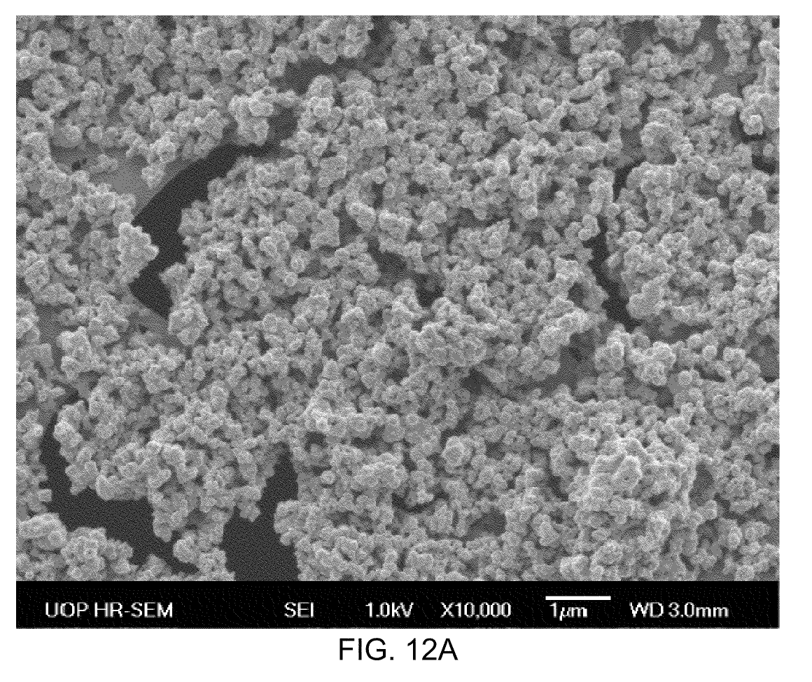

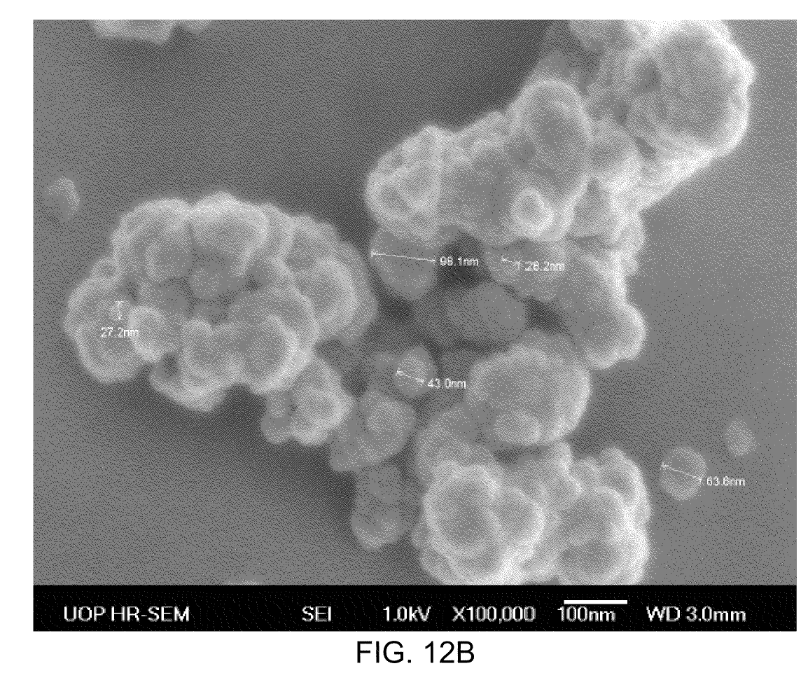

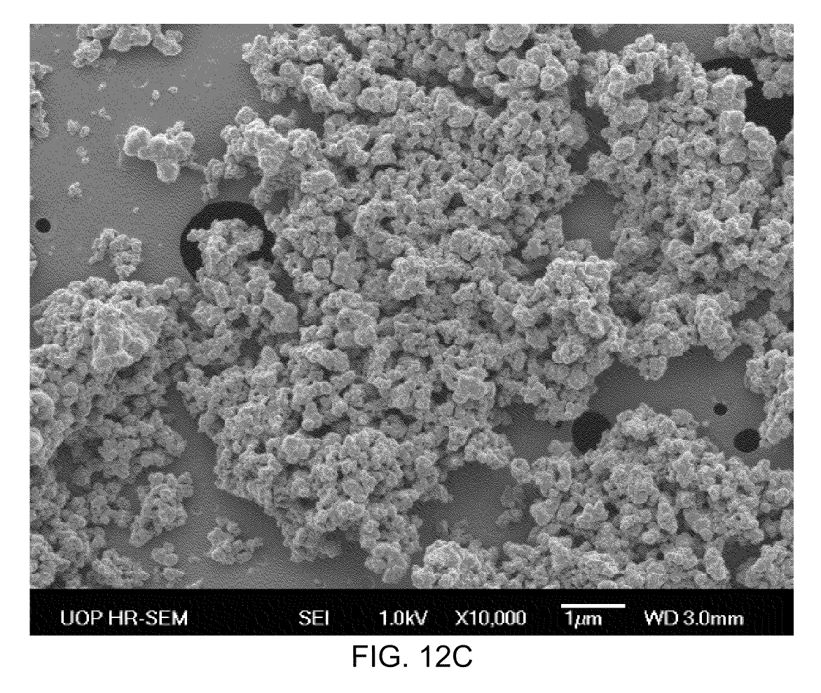

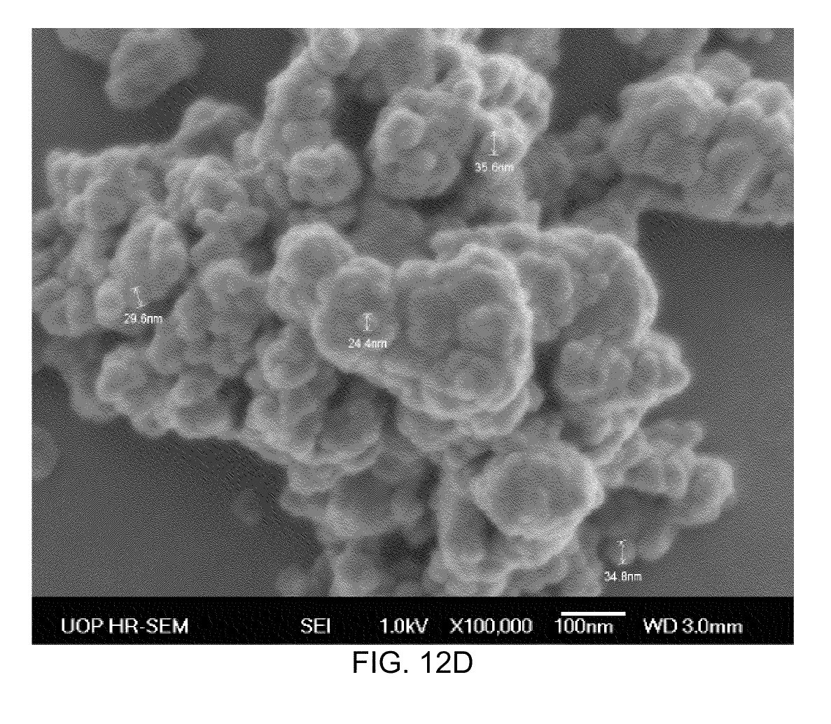

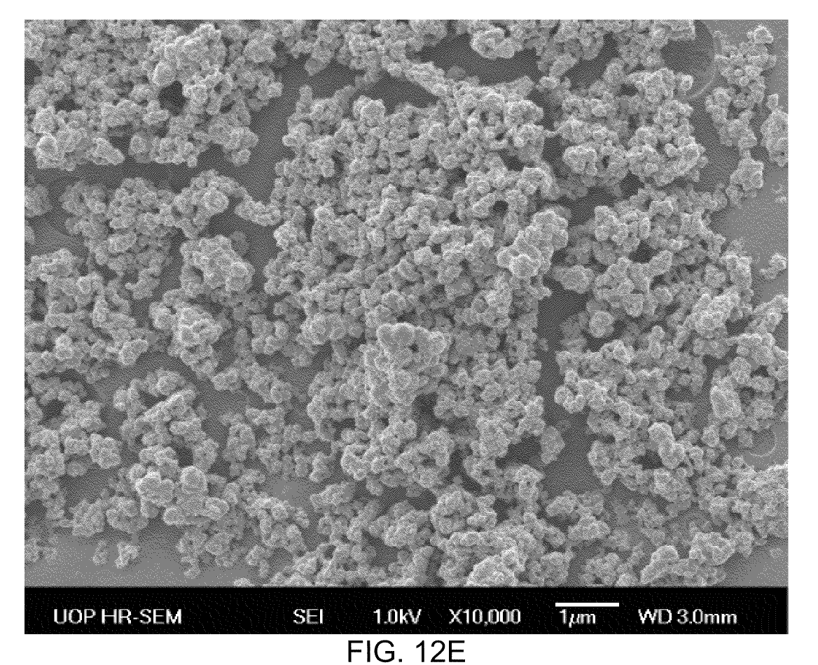

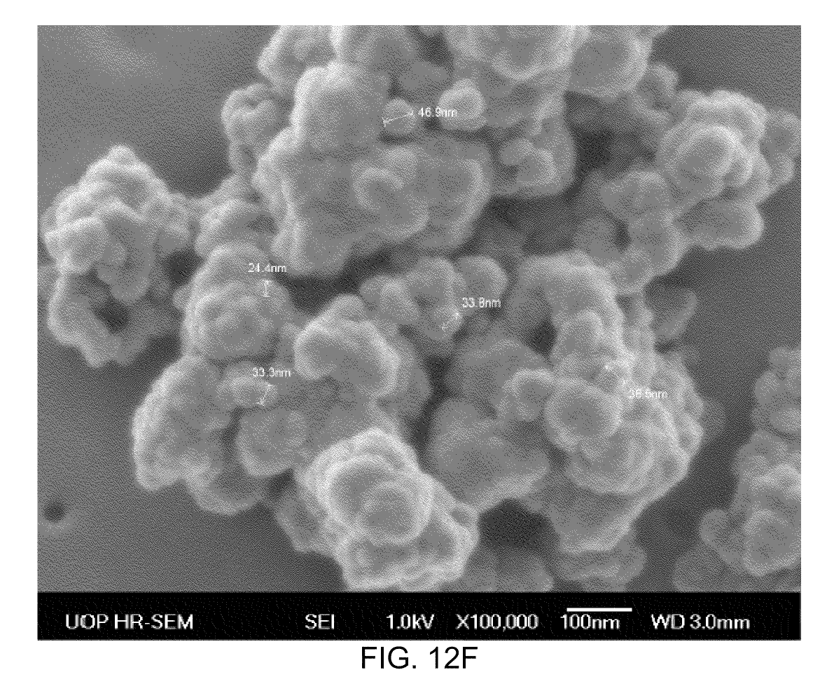

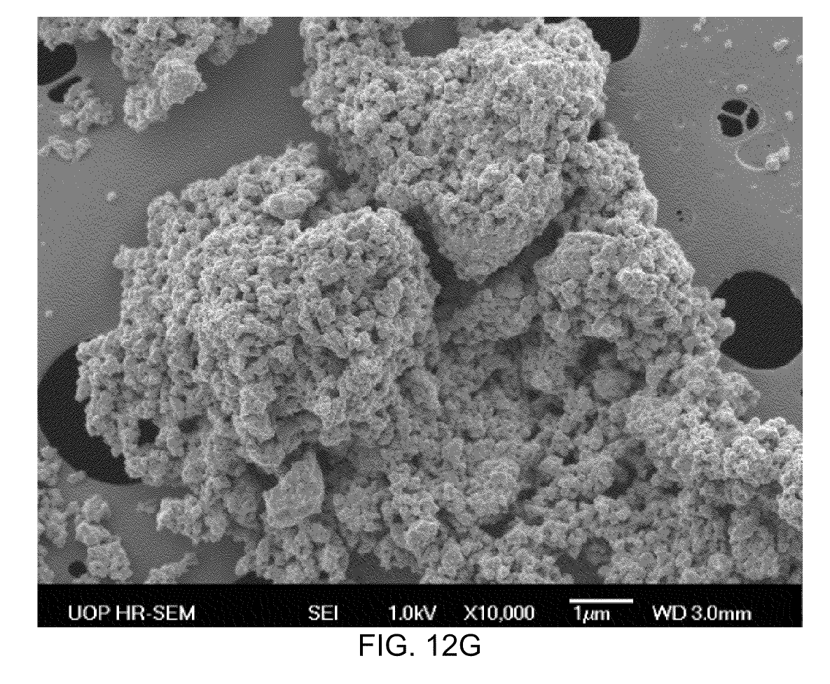

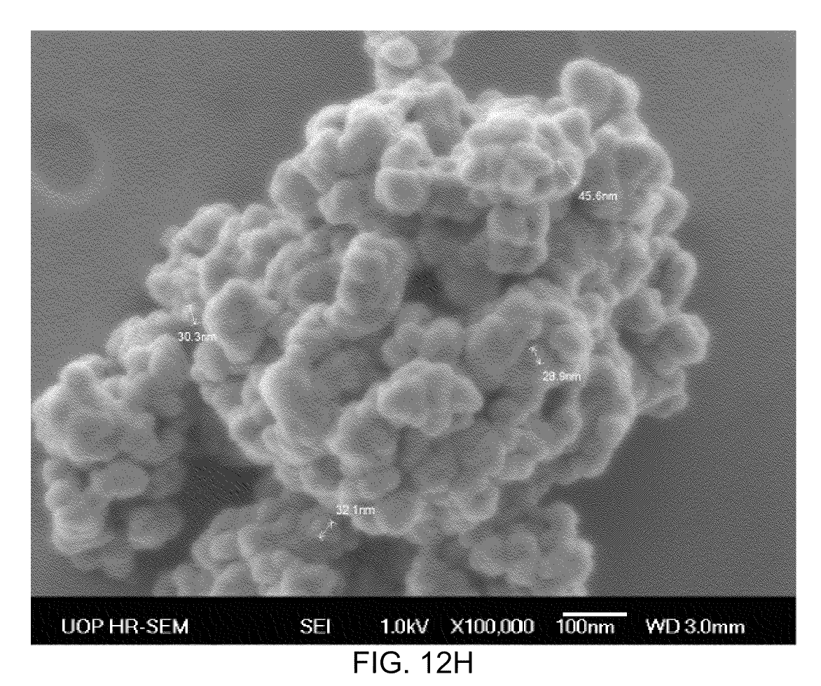

FIGS. 11A-11D and 12A-12H illustrate that different additives can be used to make Co/DOBDC crystals. FIGS. 11A-11D set forth the XRD patterns for products of Examples 5-5 through 5-8, each using a different additive at high 0.14 M reactant concentration. These patterns illustrate the consistency of product properties, despite which organic additive is used. FIG. 11E is the calculated XRD pattern for Mg/DOBDC.

FIGS. 12A-12H are SEM's at 10 k magnification and at 100 k magnification for each of the products relating to FIGS. 11A-11D. These SEM's depict the loose agglomerate nature of the product and the similarity of product using different additives, as follows:

12A and 12B—Brij30® (C₁₂E₄) (Example 5-5);

12C and 12D—C₆E₂ (Example 5-6);

12E and 12F—Brij56® (Example 5-7); and

12G and 12H—(C₁₂E₁₀) (Example 5-8).

FIG. 12B identifies representative particle sizes of 28.2 nm 43.0 nm, 63.8 nm, and 98.1 nm. FIG. 12D identifies representative particle sizes of 24.4 nm, 29.6 nm, 34.8 nm, and 35.6 nm; FIG. 12F, 24.4 nm, 33.3 nm, 33.8 nm, and 46.9 nm; and FIG. 12H, 26.9 nm, 30.3 nm, 32.1 nm, and 45.6 nm.

While the invention has been described with respect to specific examples including presently preferred modes of carrying out the invention, those skilled in the art will appreciate that there are numerous variations and permutations of the above described systems and techniques that fall within the spirit and scope of the invention as set forth in the appended claims. For example, embodiments of the invention can be directed to additional metals, additional linkers, and to additional additives.

1. A method for synthesizing particulate or loosely agglomerated nano-metal organic framework crystals having an average particle size less than 100 nm, said method comprising rapidly stirring at a temperature between about 15° C. and about 30° C. and for a time less than about 4 hours a solution comprising a metal salt and an organic polydentate ligand in solvent while adding a base compound capable of deprotonating the ligand to form a nano-metal organic framework crystals, wherein the ratio of base compound to acid function within the ligand in the solution is less than about 2:1.

2. The method of claim 1 wherein ligand is selected from the group consisting of neutral bidentate ligands, 1,4-benzene dicarboxylic acid, 1,3,5-benzene tricarboxylic acid, 1,2,4,5-benzene tetracarboxylic acid, and blends thereof.

3. The method of claim 1 wherein the ratio of base compound to acid function is between about 0.25:1 and 1.75:1.

4. The method of claim 1, wherein the solution further comprises additive selected from the group consisting of Brij surfactants, straight chain paraffins concatenated with plural ether moieties and capped with a hydroxyl moiety, and blends thereof.

5. The method of claim 1, wherein the total molal concentration of concentration of metal salt and ligand is between about 0.03 M and about 0.15 M.

6. A particulate or loosely agglomerated nano-metal organic framework crystals having an average particle size less than 100 nm made in accordance with the method of claim 1.

7. The nano-metal organic framework crystals of claim 6 having a specific surface area comprising greater than about 50 percent mesoporosity.

8. A method for synthesizing particulate or loosely agglomerated nano-metal organic framework crystals having an average particle size less than 100 nm, said method comprising rapidly stirring at a temperature between about 15° C. and about 30° C. and for a time less than about 4 hours a solution comprising a metal salt and an organic polydentate ligand in solvent while adding a base compound capable of deprotonating the ligand to form a nano-metal organic framework crystals, wherein the total molal concentration of metal and ligand in the solvent is at least about 0.08 M.

9. The method of claim 8 wherein ligand is selected from the group consisting of neutral bidentate ligands, 1,4-benzene dicarboxylic acid, 1,3,5-benzene tricarboxylic acid, 1,2,4,5-benzene tetracarboxylic acid, and blends thereof.

10. The method of claim 8 wherein the ratio of base compound to acid function is between about 0.25:1 and 1.75:1.

11. The method of claim 8, wherein the solution further comprises an additive.

12. The method of claim 11, wherein the additive is selected from the group consisting of Brij surfactants, straight chain paraffins concatenated with plural ether moieties and capped with a hydroxyl moiety, and blends thereof.

13. A particulate or loosely agglomerated nano-metal organic framework crystals having an average particle size less than 100 nm made in accordance with the method of claim 8.

14. The nano-metal organic framework crystals of claim 13 having a specific surface area comprising greater than about 50 percent mesoporosity.

15. A method for synthesizing particulate or loosely agglomerated nano-metal organic framework crystals having an average particle size less than 100 nm, said method comprising rapidly stirring at a temperature between about 15° C. and about 30° C. and for a time less than about 4 hours a solution comprising a metal salt and an organic polydentate ligand in solvent while adding a base compound capable of deprotonating the ligand to form a nano-metal organic framework crystals, wherein the solvent comprises at least two solvents.

16. The method of claim 15 wherein the ratio of base compound to acid function is between about 0.25:1 and 1.75:1.

17. The method of claim 15, wherein the solution further comprises additive selected from the group consisting of Brij surfactants, straight chain paraffins concatenated with plural ether moieties and capped with a hydroxyl moiety, and blends thereof.

18. The method of claim 15, wherein the total molal concentration of concentration of metal salt and ligand is between about 0.03 M and about 0.15 M.

19. Particulate or loosely agglomerated nano-metal organic framework crystals having an average particle size less than 100 nm made in accordance with the method of claim 15.

20. The nano-metal organic framework crystals of claim 19 having a specific surface area comprising greater than about 50 percent mesoporosity.
